(19) United States
(12) Patent Application Publication
(10) Pub. No.: US 2026/0178842 A1
(43) Pub. Date: Jun. 25, 2026

(54) SYSTEM AND METHOD FOR PROVIDING BUSINESS INFORMATION VIA AN ARTIFICIAL INTELLIGENCE-POWERED CHATBOT

(71) Applicant: NCR Voyix Corporation, Atlanta, GA (US)

(72) Inventors: Shiran Abadi, Tel Aviv (IL); Brenda Nadam-Olegnowicz, Binyamina (IL); Noa Shmulevich, Haifa (IL); Anael Engel, Yodfat (IL)

(21) Appl. No.: 18/989,625

(22) Filed: Dec. 20, 2024

(51) Int. Cl. G06F 40/40

(52) U.S. Cl. CPC G06F 40/40

(57) ABSTRACT

A system and method is described for providing information in response to a natural language question. A user question is received in natural language. Information about available business information sources and the user question is forwarded to a large language model to identify a relevant business information source. The relevant business information source and the user question is forwarded to the large language model to generate a query to retrieve information needed to answer the user question from the relevant business information source. The query is executed on the relevant business information source to retrieve the information needed to answer the user question. The retrieved information is forwarded to the large language model to format the retrieved information into a human-readable response. The human-readable response is presented to the user.

### FIELD

This disclosure relates generally to a system and method for providing business information via an artificial intelligence-powered chatbot, and more particularly to a system and method which combines an application programming interface linked to obtain business information from business information sources and a large language model used to analyze the business information obtained by the application programming interface in order to provide more accurate responses to user queries.

### BACKGROUND

Recent advancements in generative artificial intelligence (AI) have led to the development of chatbot-based systems designed to retrieve analytics information for users. These systems function by receiving a user query (e.g., “What was the sales amount in my store last week?”), which is interpreted by the generative AI model. The model then retrieves the relevant data from a business intelligence (BI) resource, such as a database or an analytics report, and returns the information in a human-readable format.

While generative AI models may be adept at understanding the technical structure of data, they often lack the business domain knowledge necessary to fully comprehend the intent behind a user query. For example, the model may know how to retrieve a “sales amount” from a database but may not understand whether the user is asking for the net amount, tax-inclusive amount, or revenue, or whether adjustments for discounts or returns are required. Moreover, generative AI models often lack contextual awareness of specific information sources, e.g., dashboards or reports, which can lead to fetching data from incorrect sources or misinterpreting the information.

This lack of business domain knowledge and contextual awareness in generative AI models presents challenges in providing accurate and contextually relevant answers, especially when dealing with complex or industry-specific terminology or when a user query uses non-technical, colloquial language.

These challenges highlight the need for enhanced systems that can better interpret the business context, ensuring that a user is provided with the most relevant and accurate data in response to a query.

### BRIEF DESCRIPTION OF THE DRAWINGS

The following detailed description, given by way of example and not intended to limit the present disclosure solely thereto, will best be understood in conjunction with the accompanying drawings in which:

FIG. 1 is a block diagram of a system for providing business information via an artificial intelligence-powered chatbot according to an aspect of the current disclosure;

FIG. 2 is a flow diagram of a method for providing business information via an artificial intelligence-powered chatbot for use in the system of the current disclosure; and

FIG. 3 is a block diagram of a computing device for use in the system of the current disclosure.

### DETAILED DESCRIPTION

In the present disclosure, like reference numbers refer to like elements throughout the drawings, which illustrate various exemplary embodiments of the present disclosure.

The present disclosure introduces a system and method for enhancing conversational AI workflows by integrating a curated, business-oriented user guide that describes the data available in business information sources such as reports, dashboards, and databases. By embedding this knowledge into the AI model, the system is able to interpret user queries more accurately and retrieve the appropriate data from the correct sources.

The system involves two key components. First, a curated user guide is prepared by those knowledgeable of the business information sources (e.g., domain experts) that will be presented to the AI model (LLM). The curated user guide describes the predetermined business information sources in terms of dashboards and databases, fields therein, and the meanings of such fields in business-relevant terms. This user guide serves as a bridge between a user's natural language query and the LLM's technical query generation capabilities, enabling the LLM to better understand the user intentions and map them to the correct business information source, e.g., a particular report and field therein. Second, a complete workflow integrates the user guide into a conversational AI chatbot. The AI chatbot processes natural language queries, uses the user guide to identify a relevant dashboard, generates a necessary query, fetches the data, and presents the result to the user in a human-readable format. The system leverages both a generative AI model for language processing and embedding models for identifying the most relevant reports. By combining these models, the system ensures a high level of accuracy in identifying the correct data and generating meaningful responses for the user.

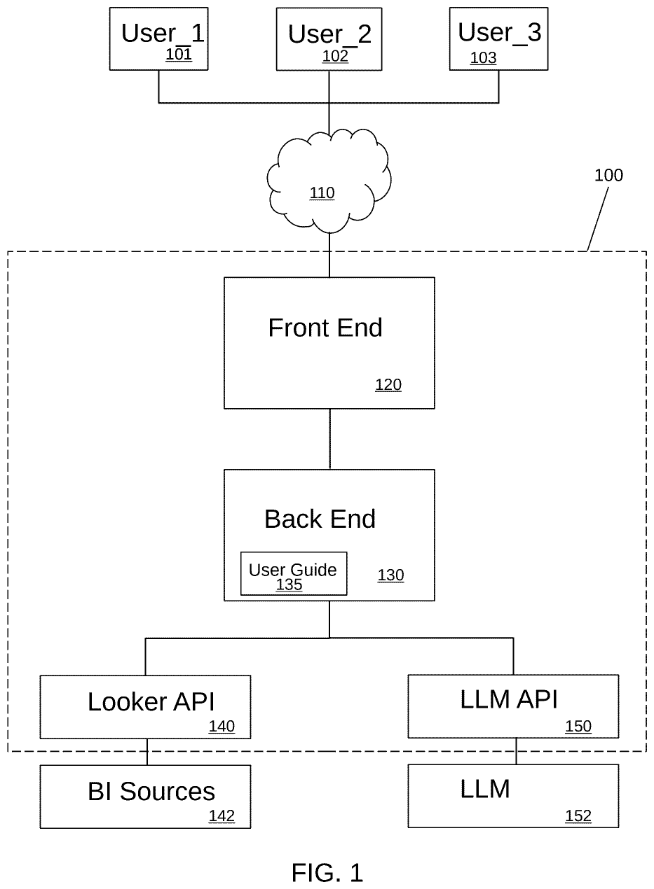

Referring now to the block diagram of FIG. 1, a system 100 for providing business information via an artificial intelligence-powered chatbot includes a front end 120 coupled to a plurality of users, exemplified by user_1 101, user_2 102, and user_3 103, via a network 110, e.g., a wide area network such as the Internet. The front end 120 may include a web server for communication with the users via a network protocol such as HTTP or HTTPS. The front end 120 serves as the external face of the system 100, providing an interface to each user to enter a query and, once the query is fully processed, providing a response to the user's query.

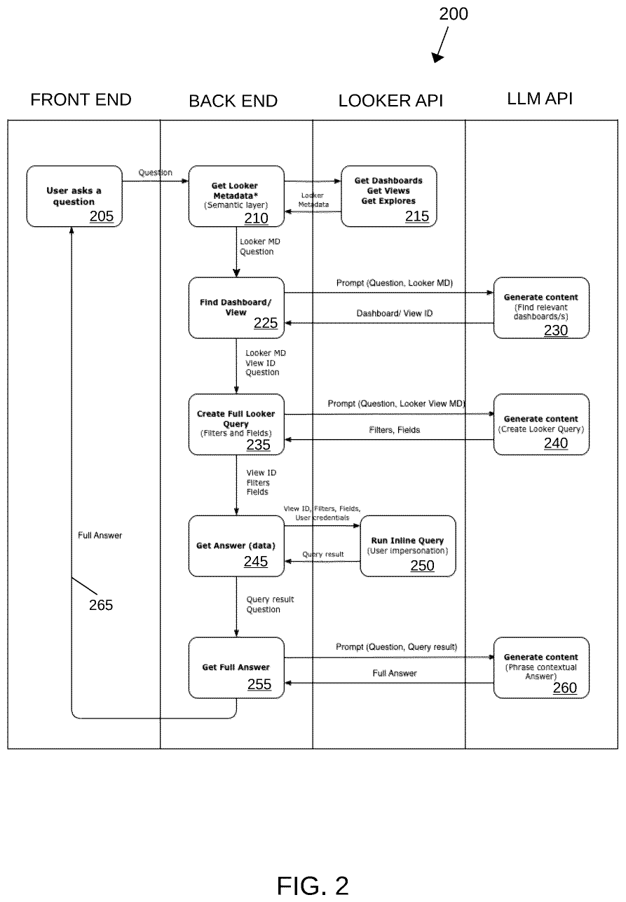

System 100 also includes a back end 130 which controls the processing of the chatbot, as specifically defined with respect to FIG. 2, a looker application programming interface (API) 140 for communicating with predetermined business information (BI) sources 142, and a large language model (LLM) API 150 for communication with a predetermined LLM 152. A user guide 135 which includes curated business information related to the predetermined business information sources is stored in a memory within the back end 130. The operation of the front end 120, the back end 130, the Looker API 140 and the LLM API 150 are explained with respect to the flow diagram of FIG. 2.

Referring now to the flowchart 200 in FIG. 2, the process begins when the front end 120 receives a question from a user (step 205). The question is typically related to data or business intelligence that the system will need to provide. The user might ask for specific business insights, metrics, or data points, which are then passed into the system 100 for further processing.

The back end 130 receives the question and, optionally, first requests metadata from the Looker API (step 210) related to structural information about dashboards, views, and data models available in the business information (BI) sources 142 coupled to the Looker API 140. This metadata helps the system 100 understand the structure of the data and the available reports or views that might be relevant to the user's question.

The Looker API 140 responds to the request and provides a set of metadata that includes information about available dashboards, views, and explores that define the available BI sources 142 (step 215). The dashboards and views are specific visualizations or data sets and explores are predefined datasets that may be queried within the available BI sources 142. The Looker API is a RESTful API that allows developers to interact programmatically with Looker, a business intelligence and data visualization platform. The API enables users to automate tasks, manage user permissions, interact with Looker's dashboards, extract data, create and manage content, and integrate Looker with other applications or workflows. In the alternative, other products may be used to perform this function, e.g., Power BI from Microsoft®, or a combination of Looker and database querying may be implemented to improve latency.

At step 225, the back end 130 sends the user's question, the user guide content, and the metadata retrieved from the Looker API 140 to LLM API 150. The LLM API 150 forwards this information to LLM 152 (e.g., an AI model such as generative AI or an embedding model). LLM 152 analyzes the question and metadata and uses the user guide to identify the most relevant dashboard and associated view for use in answering the user's query and forwards the identified dashboard/view to the back end 130 via the LLM API 150 (step 230). The user guide is therefore used to connect between the user's question, written in the user's language, and the metadata content.

At step 235, the back end 130 sends the identified dashboard/view information, along with the user's original question, to the LLM API 150, which forwards this information to the LLM 152. The LLM 142 processes the question and the identified dashboard/view and generates a full query that will be used to retrieve data from the BI sources 142 via the Looker API 140 (step 240). This full query specifies the particular data and/or metrics to be extracted and is provided to the back end 130 via the LLM API 150.

At step 245, the back end 130 sends the full query and the identified dashboard/view to the Looker API 140, which runs the full query of the identified dashboard view (step 250). The full query results are then returned to the back end 130.

At step 255, the full query results are sent to the LLM API 150, which forwards them to the LLP 152. The LLM 152 processes and formats the full query results into a textual answer that is understandable to the user (step 260). The textual answer is formatted as a well-structured, user-friendly response, which, for example, could be in the form of a text answer, table, or summary that directly addresses the user's question. The textual answer is provided to the back end 130, which forwards it to the front end 120 for display to the user (step 265).

The flowchart 200 outlines the process of leveraging a combination of curated business knowledge and an LLM to intelligently answer user queries by querying the appropriate business data and presenting it in a clear format.

### Example Workflow

In an example workflow, a user may ask “What was the sales amount in my store last week?”

The system 100 first identifies that the relevant information can be found in the “weekly store summary” dashboard (steps 225-230).

The system 100 then constructs a query based on the dashboard details, including relevant filters (steps 235-240).

The system fetches the data based on the query and returns the result: $ 546,091 (steps 245-250).

Finally, the response is formatted for the user: “The sales amount in your store last week was $546,091. This information is based on the ‘weekly store summary’ dashboard [link]” (steps 255-260).

In some cases, the system 100 may find that multiple dashboards match a query. The system 100 may provide several options in addressing this. First, the system 100 may execute the query for each dashboard and returns the answer based on the majority vote. Second, the system 100 may initially use the most likely dashboard and, if the query fails, retry with the next most likely option. Third, the system 100 may query the user for clarification regarding which dashboard is believed to be most relevant.

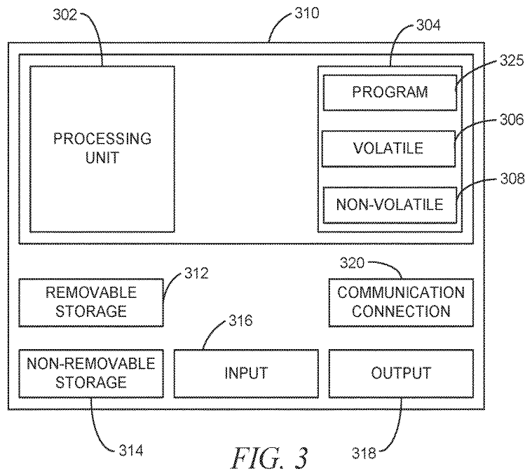

FIG. 3 is a block diagram of a computing device 310, according to an example embodiment, for use in the system and method of the present disclosure. In one embodiment, multiple such computer systems are utilized in a distributed network to implement multiple components in a transaction-based environment. An object-oriented, service-oriented, or other architecture may be used to implement such functions and communicate between the multiple systems and components. One example computing device in the form of a computer 310, may include a processing unit 302, memory 304, removable storage 312, and non-removable storage 314. Memory 304 may include volatile memory 306 and non-volatile memory 308. Computer 310 may include or have access to a computing environment that includes a variety of computer-readable media, such as volatile memory 306 and non-volatile memory 308, removable storage 312 and non-removable storage 314. Computer storage includes random access memory (RAM), read-only memory (ROM), erasable programmable read-only memory (EPROM) & electrically erasable programmable read-only memory (EEPROM), flash memory or other memory technologies, compact disc read-only memory (CD-ROM), Digital Versatile Disks (DVD) or other optical disk storage, magnetic cassettes, magnetic tape, magnetic disk storage or other magnetic storage devices, or any other medium capable of storing computer-readable instructions. Computer 310 may include or have access to a computing environment that includes input 316, output 318, and a communication connection 320. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network WAN) or other networks.

Computer-readable instructions stored on a computer-readable medium are executable by the processing unit 302 of the computer 310. A hard drive, CD-ROM, and ROM are some examples of articles constituting a non-transitory computer-readable medium. For example, a computer program 325 capable of performing one or more of the methods or providing one or more functions illustrated and described herein. The front end 120, the back end 130, the Looker API 140, and the LLM API 150 may all be provided on a single computing device 310 as computer-readable instructions stored in non-volatile memory 308, in one exemplary embodiment.

Although the present disclosure has been particularly shown and described with reference to the preferred embodiments and various aspects thereof, it will be appreciated by those of ordinary skill in the art that various changes and modifications may be made without departing from the spirit and scope of the disclosure. It is intended that the appended claims be interpreted as including the embodiments described herein, the alternatives mentioned above, and all equivalents thereto.

What is claimed is:

1. A method for providing information in response to a natural language question, comprising:
receiving a question in natural language from a user;
forwarding information about available business information sources and the question to a large language model to identify a relevant business information source;
forwarding the relevant business information source and the question to the large language model to generate a query to retrieve information for answering the question from the relevant business information source;
executing the query on the relevant business information source to retrieve the information for answering the question;
forwarding the retrieved information to the large language model to format the retrieved information into a human-readable response; and
presenting the human-readable response to the user.

2. The method of claim 1, wherein the information about available business information is a predefined user guide.

3. The method of claim 2, wherein the predefined user guide describes dashboards and/or databases of available business information.

4. The method of claim 3, wherein the predefined user guide describes fields in the dashboards and/or databases.

5. The method of claim 4, wherein the predefined user guide provides a definition of fields in the dashboards and/or databases.

6. The method of claim 1, wherein the relevant business information source is a predefined dashboard and/or a predefined database.

7. The method of claim 1, wherein, when the large language model identifies more than one relevant business information source, executing the query on each identified relevant business information source to retrieve the information for answering the question and selecting an appropriate answer based on majority vote.

8. The method of claim 1, wherein, when the large language model identifies more than one relevant business information source, allowing the user to select which of the identified business information sources to query.

9. The method of claim 1, wherein, when the large language model identifies more than one relevant business information source, executing an initial query on a first most likely one of the identified relevant business information sources to retrieve the information for answering the question and then, when the initial query fails, executing a follow-up query on a second most likely one of the identified relevant business information sources to retrieve the information for answering the question.

10. The method of claim 1, wherein the step of executing the query on the relevant business information source to retrieve the information for answering the question is done via one of a Looker API interface and a Power BI interface.

11. A system for providing information in response to a natural language question, comprising:
a server comprising at least one processor and an associated non-transitory computer-readable storage medium, the non-transitory computer-readable storage medium comprising executable instructions which, when executed by at least one processor in the server, cause the at least one processor to perform operations, comprising:
receiving a question in natural language from a user;
forwarding information about available business information sources and the question to a large language model to identify a relevant business information source;
forwarding the relevant business information source and the question to the large language model to generate a query to retrieve information for answering the question from the relevant business information source;
executing the query on the relevant business information source to retrieve the information for answering the question;
forwarding the retrieved information to the large language model to format the retrieved information into a human-readable response; and
presenting the human-readable response to the user.

12. The system of claim 11, wherein the information about available business information is a predefined user guide.

13. The system of claim 12, wherein the predefined user guide describes dashboards and/or databases of available business information.

14. The system of claim 13, wherein the predefined user guide describes fields in the dashboards and/or databases.

15. The system of claim 14, wherein the predefined user guide provides a definition of fields in the dashboards and/or databases.

16. The system of claim 11, wherein the relevant business information source is a predefined dashboard and/or a predefined database.

17. The system of claim 11, wherein, when the large language model identifies more than one relevant business information source, executing the query on each identified relevant business information source to retrieve the information for answering the question and selecting an appropriate answer based on majority vote.

18. The system of claim 11, wherein, when the large language model identifies more than one relevant business information source, allowing the user to select which of the identified business information sources to query.

19. The system of claim 1, wherein, when the large language model identifies more than one relevant business information source, executing an initial query on a first most likely one of the identified relevant business information sources to retrieve the information for answering the question and then, when the initial query fails, executing a follow-up query on a second most likely one of the identified relevant business information sources to retrieve the information for answering the question.

20. The system of claim 1, wherein the step of executing the query on the relevant business information source to retrieve the information for answering the question is done via one of a Looker API interface and a Power BI interface.
